(19) United States
(12) Patent Application Publication
(10) Pub. No.: US 2006/0020397 A1
(43) Pub. Date: Jan. 26, 2006

(54) Methods for nucleic acid and polypeptide similarity search employing content addressable memories

(76) Inventor: Bahram Ghaffarzadeh Kermani, San Diego, CA (US)

Correspondence Address: MCDERMOTT, WILL & EMERY, 4370 LA JOLLA VILLAGE DRIVE, SUITE 700, SAN DIEGO, CA, 92122, US

(21) Appl. No.: 10/896,771

(22) Filed: Jul. 21, 2004

(51) Int. Cl. G06K 9/00

(52) U.S. Cl. 702/20

(57) ABSTRACT

This invention is directed to systems and methods for comparing the similarity of biopolymer sequences. Algorithms useful in the systems and methods of the invention include (a) parsing one or more biopolymer reference sequences to produce a plurality of reference subsequences; (b) storing the plurality of reference subsequence to a plurality of CAM address locations; (c) parsing a query sequence to produce a plurality of query subsequences; (d) searching the plurality of reference subsequences stored in the plurality of CAM address locations with the plurality of query subsequences, and (e) producing an output of CAM address locations containing at least one match, the at least one match indicating sequence similarity between the reference subsequence stored in the CAM address location and the query subsequence producing the at least one match.

### BACKGROUND OF THE INVENTION

This invention relates generally to genomics and related bioinformatic methods for processing nucleic acid sequence information and, more specifically to systems and methods for the efficient analysis of sequence similarity.

The human genome project has resulted in the generation of enormous amounts of DNA sequence information. The generation of this information and achievement of the complete sequencing of the human genome has required numerous technical advances both in sample preparation and sequencing methods as well as in data acquisition, processing and analysis. During the project's quick evolution, it has brought to fruition the scientific fields of genomics, proteomics and bioinformatics.

Advancements in automated sequencing procedures and the genomic era emphasis on data acquisition has resulted in the accumulation of a vast amount of sequence data. However, the ability to organize, analyze and interpret archives of sequence information into biologically relevant contexts has been lagging. For example, genomic sequence databases contain an enormous content of sequence information, but only a small portion of such databases constitute unique sequence information. This problem is further complicated by the magnitude of new sequence information being generated on a daily basis.

Accessing, analyzing or employing sequence information in a meaningful way generally requires a need for a sequence similarity search algorithm. However, the available algorithms that perform sequence similarity searches lack the speed or practical ability to process the existing amount of the data, in a seamless manner or efficient manner. Therefore, one challenge continues to be how to efficiently tap into sequence information or extract and use the meaningful portion of sequence information to address a particular problem.

Thus, there exists a need for a system and related methods that enable the rapid and efficient processing of sequence information. The present invention satisfies this need and provides related advantages as well.

### SUMMARY OF THE INVENTION

The invention provides a method of determining the similarity of two or more biopolymer sequences. The method includes the computer implemented steps: (a) parsing one or more biopolymer reference sequences to produce a plurality of reference subsequences; (b) storing the plurality of reference subsequence to a plurality of CAM address locations; (c) parsing a query sequence to produce a plurality of query subsequences; (d) searching the plurality of reference subsequences stored in the plurality of CAM address locations with the plurality of query subsequences, and (e) producing an output of CAM address locations containing at least one match, the at least match indicating sequence similarity between the reference subsequence stored in the CAM address location and the query subsequence producing the at least one match.

Also provided is a method of determining the similarity of two or more biopolymer sequences. The method includes the computer implemented steps: (a) parsing one or more biopolymer reference sequences to produce a plurality of reference subsequences; (b) storing the plurality of reference subsequence to a plurality of CAM address locations in an order corresponding to an unparsed sequence of the reference sequence; (c) parsing a query sequence to produce a plurality of query subsequences; (d) searching the plurality of reference subsequences stored in the plurality of CAM address locations with the plurality of query subsequences; (e) producing an output of CAM address locations containing at least one match, the at least one match indicating sequence similarity between the reference subsequence stored in the CAM address location and the query subsequence producing the at least one match, and (f) identifying a contiguous order of CAM address locations containing at least one match, wherein the contiguous order indicates sequence similarity between the reference sequence and the query sequence.

The invention also provides an integrated system for comparing the similarity of two or more biopolymer sequences. The integrated system includes the computer implemented steps: (a) a programmable logic device containing a CAM, and (b) an alignment algorithm. The alignment algorithm includes the computer implemented steps: (1) parsing one or more biopolymer reference sequences to produce a plurality of reference subsequences; (2) storing the plurality of reference subsequence to a plurality of CAM address locations; (3) parsing a query sequence to produce a plurality of query subsequences; (4) searching the plurality of reference subsequences stored in the plurality of CAM address locations with the plurality of query subsequences, and (5) producing an output of CAM address locations containing at least one match, the at least one match indicating sequence similarity between the reference subsequence stored in the CAM address location and the query subsequence producing the at least one match.

### BRIEF DESCRIPTION OF THE DRAWINGS

FIG. 1 shows a flowchart of an algorithm useful in the invention.

FIG. 2 shows a block diagram of a simplified 4×5 bit ternary CAM with a NOR-based architecture.

FIG. 3 shows a SRAM storage cell (Panel A), binary CAM cell (Panel B) and ternary CAM cell (Panel C).

FIG. 4 shows the matchline of a NOR-based CAM.

### DETAILED DESCRIPTION OF THE INVENTION

This invention is directed to systems and methods for comparing the similarity of biopolymer sequences. Sequence similarity or alignment routines are important to the fields of genomics, proteomics and bioinformatics as well as for the production or improvement of biopharmaceuticals and pharmaceuticals. The system and methods of the invention provide hardware, algorithms and processes employing content addressable memory (CAM) for the rapid and efficient determination of single or multiple sequence comparisons. The CAM-containing system and CAM-based methods of the invention can provide advantages over current alignment algorithms such as local, global or heuristic local searches because they are rapid, associative, and provide simultaneous searching of content in a single or a few clock-cycles. Additionally, the CAM-containing systems and CAM-based methods of the invention are flexible and modular to allow expansion or contraction of memory size to suit essentially any desired application. Such attributes can result in a reduction of one or more orders of magnitude in sequence search time over traditional algorithm-based searches. The systems and methods of the invention have a wide range of applications in biopolymer database search systems and hardware.

In one specific embodiment, the invention is directed to an integrated system employing a CAM for implementation of a DNA sequence search. The CAM component of the system can be pre-loaded with data or it can be written during operation. Loaded data corresponding to reference DNA sequence information is parsed into units equivalent to the memory width of the CAM. Positioning of the parsed reference unit sequences can correlate to the physical location of the units within the contiguous or unparsed reference DNA sequence. Sequence searching is performed by similarly parsing the query sequence into units equal in size to the loaded data units and each parsed query sequence is compared to the sequence data resident in each CAM address to identify all matches with each query sequence. The output corresponds to the CAM addresses of the reference sequences matching the query sequence, where identification of a contiguous space will indicate a match of the query sequence to the DNA reference sequence loaded in the CAM.

As used herein, the term “similarity” when used in reference to a comparison of two or more biopolymer sequences is intended to mean the degree of sequence correspondence between two sequences. The degree of correspondence includes the amount of agreement or resemblance between two or more sequences and can be represented, for example, as a degree of sequence identity or alignment between two or more sequences. Such sequence similarity alignments refer to a representation of two or more sequences sharing matches, mismatches or gaps at each monomer position when placed in proper relative position or orientation. Therefore, the degree to which positions match or correctly align is a measure of their sequence similarity. Sequences that completely match, without mismatches or gaps, are considered identical. Gaps can occur, for example, due to insertion or deletion of a sequence region in a first sequence compared to a second sequence. In contrast, sequences that do not align, or that exhibit a frequency of matching positions expected to occur by chance, are considered non-identical. Sequences that align with match frequencies greater than chance are considered significant and fall within the meaning of the term “similar” as used herein. A biopolymer sequence, or region thereof, is considered to have substantial sequence similarity when the degree of sequence alignment between compared sequences are the same, or are deemed to be the same, given for example, the error rate inherent in input data, the algorithm used for comparison or the search and alignment parameters employed in a particular run analysis. Given a particular computational background and sequencing data source, those skilled in the art will know, or can determine, a range or boundary of nucleotide or amino acid match that is acceptable for deeming two sequences to be the same.

As used herein, the term “biopolymer” is intended to mean a polymer corresponding to a chemical compound or composite of chemical compounds formed by polymerization of monomeric subunits in a biological system. Biopolymers can include a high or low molecular weight polymer such as a macromolecule consisting of a few or many repeating monomers of relatively low molecular weight. Particular classes of biopolymers include, for example, a copolymer, dimer, homopolymer or heteropolymer. Specific examples of macromolecular biopolymers include, for example, nucleic acids, polypeptides, polysaccharides and lipids. Monomers of macromolecules include, for example, nucleotides as the repeating building blocks or subunits of nucleic acids, amino acids for polypeptides, carbohydrates for polysaccharide and fatty acids for lipids. Biopolymers can be composed of naturally occurring monomers as well as non-naturally occurring monomers including, for example, analogs, derivatives and mimetics thereof. Accordingly, specific biopolymers can be formed biosynthetically or by chemical synthesis. Polymers formed by biosynthesis well known in the art other than those described above also are included within the definition of the term as it is used herein. Because the algorithms, methods and processes described herein search, manipulate, analyze and process character string content or information, those skilled in the art will understand that the methods of the invention can be employed equally with any biopolymer sequence composed of monomer building blocks.

As used herein, the term “sequence” is intended to mean the primary sequence of a biopolymer. Therefore, the term refers to the linear order of monomers of a biopolymer. For example, when used in reference to a typical nucleic acid, the term refers to the linear order of monomer bases A, T, G, C or U (adenine, thymine, guanine, cytosine or uracil, respectively). When used in reference to a typical polypeptide, the term refers to the linear order of the 20 amino acids used in polypeptide biosynthesis. The twenty amino acids, their codons and their one or three letter symbols are known in the art as described, for example, in Branden and Tooze, Introduction to Protein Structure Garland Publishing, New York (1991). A sequence also can include non-naturally occurring monomers as exemplified above. A sequence also can include one or more modified monomers, such as methylated, phosphorylated, glycosylated, oxidized or prenylated versions of amino acids and nucleotides.

Furthermore, a sequence can be a character string representing the primary sequence of a biopolymer. The character string can include a wildcard character that is representative of degeneracy at a position in the string. For example, a wildcard character can represent degeneracy in the presence of U or T, which can be useful if both RNA and DNA sequences are being searched. Exemplary nucleic acid wildcards that are useful include, but are not limited to, Y which represents pyrimidines such as U, T or C; R which represents purines such as G or A; K which represents ketone-containing bases such as G or T; M which represents amino containing bases such as A or C; S which represents bases that make 3-hydrogen bond interactions such as G or C; W which represents bases that make 2-hydrogen bond interactions such as A, U or T; B which represents G, T or C, not A; D which represents G, A or T, not C; H which represents A, T or C, not G; V which represents G, A or C, not T; N which represents any nucleotide; or Gap which represents a gap of unknown length. Further examples include characters that represent two or more amino acids such as a character representing amino acids with one or more of charged side chains, acidic side chains, polar side chains, non polar side chains, aliphatic side chains or aromatic side chains. Those skilled in the art will recognize that any convenient symbol or representation can be used for the groups of nucleotides or amino acids exemplified by the wildcards above.

As used herein, the term “reference sequence” is intended to mean the monomeric sequence of a defined biopolymer molecule. When used in reference to a nucleic acid, for example, a reference sequence will correspond to a defined nucleotide sequence including the data or information content corresponding to a defined nucleotide sequence. Similarly, when used in reference to polypeptide, for example, a reference sequence will correspond to a defined amino acid sequence, including the data or information content corresponding to a defined amino acid sequence. A reference sequence of the invention can constitute any form of nucleotide, amino acid or other biopolymer sequence for which a user desires to form the basis of a comparison for obtaining sequence similarity information or sequence identification.

Particular forms of nucleic acids for which sequence similarity information can be desired include, for example, genomic nucleic acids and nucleic acids corresponding to genes, such as gene structural regions or expressed sequences, such as expressed sequence tags (ESTs) and copied messenger RNA (cDNA). Nucleotide sequence information for any of the above exemplary forms of nucleic acids can be obtained from, for example, sequence databases, publications or directly from raw sequence data. Particular forms of polypeptides for which sequence similarity information can be desired can include, peptide, polypeptide, protein, or any of the above forms of coding region nucleic acid translated into primary amino acid sequence. Similarly, amino acid sequence information for such exemplary forms of polypeptides also can be obtained from sequence databases, proteomic databases or from raw data, for example. Forms of polysaccharide, lipid or other biopolymers for which sequence similarity information can be desired will similarly be well known to those skilled in the art. Therefore, a reference sequence constitutes any biopolymer that contains a defined primary monomer sequence which is known or can be determined as well as fragments or portions of larger biopolymers. A reference sequence can be represented, for example, as a single sequence or as multiple component fragment sequences, for which a sequence similarity or identification is to be made.

As most naturally occurring nucleic acids derive from genomic nucleic acid, a reference to a specific type of nucleic acid sequence is intended to refer to a subcategory of a genomic nucleic sequence. Similarly, and unless specifically referred to otherwise, the use of the general term “nucleic acid” without reference to genomic or a subcategory thereof of genetic information is intended to include both naturally occurring and non-naturally occurring nucleic acids or nucleotide sequences. For example, genomic sequences can contain genetic structural regions, such as a gene, including exons, introns promoters, 5′ untranslated regions (UTRs), 3′ UTRs or other substructures thereof, intragenic region sequence, centromeric region sequence, or telomeric region sequence, as well as other chromosomal regions well known to those skilled in the art. Genes encompass the genetic structural elements encoding a polypeptide or structural or functional RNA or DNA, or a fragment thereof. Similarly, as all naturally occurring peptides, polypeptides and proteins derive from coding region nucleic acid, a reference to a specific type of coding region nucleic acid sequence also is intended to refer to its translated amino acid sequence. Similarly, and unless specifically referred to otherwise, the use of the general terms “amino acid sequence” or “polypeptide” is intended to include both naturally occurring and non-naturally occurring polypeptides or amino acid sequences.

Because the algorithms and corresponding methods are equally applicable to searching all types of monomer-composed polymer sequences, those skilled in the art will understand that where a biopolymer is encoded by another biopolymer form, one can implement the methods of the invention in search routines employing either its encoded form, translated from or reverse-translated form. For example, sequence comparison or identification can be performed on a nucleotide sequence in nucleic acid computational space or it can be translated into amino acid sequence and performed in polypeptide computational space. The former will yield nucleotide sequence similarity information and the latter will yield amino acid sequence similarity information. Further, for example, an amino acid sequence can be searched directly in polypeptide computational space to yield amino acid sequence similarity information, or alternatively, it can be reverse translated into one or more coding nucleotide sequence and searched in nucleic acid computational space to yield nucleotide sequence similarity information. Therefore, the sequence similarity and identification methods of the invention also are applicable for sequence analysis in translated or reverse translated computational search space.

As used herein, the term “query sequence” is intended to mean a biopolymer's sequence for which a request for sequence similarity information has been made to one or more CAM address locations. Accordingly, a query sequence refers to a biopolymer molecule of interest that is probed for containing sequence similarity matches with one or more reference sequences or a subsequence thereof. A query sequence that partially aligns with a reference sequence will contain, as the aligned portion, nucleotide sequence similarity with the reference sequence. Regions of partial alignment can be located, for example, within an internal or terminal portion of a reference or query sequence. As with reference sequences of the invention, a query sequence of the invention can constitute any type or form of biopolymer sequence for which a user desires to obtain primary sequence similarity information. Such biopolymers include, for example, nucleic acid, polypeptide, polysaccharide or lipid, which can correspond, for example, to genomic, gene, EST or cDNA nucleic acid forms, peptide, polypeptide, protein or amino acid sequence corresponding to nucleic acid coding region sequence or ORF sequence as well as carbohydrate or fatty acid.

As used herein, the term “subsequence” is intended to mean a contiguous primary sequence of a portion of a biopolymer. Accordingly, the term refers to the linear order of monomers constituting a part or region of a larger biopolymer.

As used herein, the term “parse” or “parsing” is intended to mean the process of dividing or resolving a biopolymer sequence into component parts that can be manipulated or analyzed. Accordingly, the term includes the processing of sequence information or content such as character strings into components such as words or tokens.

As used herein, the term “plurality” is intended to mean two or more different referenced molecules or sequences. Therefore, a plurality constitutes a population of two or more different members. Pluralities can range in size from small, to large, to very large. The size of small pluralities can range, for example, from a few members to tens of members. Large pluralities can range, for example from about 100 members to hundreds of members. Similarly, very large pluralities can range from about 1000 members, to thousands, tens of thousands, hundreds of thousands and greater than one million members. Therefore, a plurality can range in size from two to well over one million members as well as all sizes, as measured by the number of members, in between. Accordingly, the definition of the term is intended to include all integer values greater than two. An upper limit of a plurality of the invention can be set by a limit such as the available computational power.

As used herein, the term “CAM” or “content addressable memory” is intended to mean a storage device having associative memory function that includes comparison logic with some or all bits of storage. A CAM allows access of information in parallel within about one or a few clock cycles. A data value is broadcast to all words of storage, or a specified portion thereof, and compared with the values stored at each address. Words which match are flagged and an output is generated corresponding to the address of the flagged storage location. A CAM therefore includes data parallel or single instruction/multiple data (SIMD) processing operations where a user provides the data and gets back the address of the stored content identified by the query data. CAMs can include, for example, key data and association data stored in a memory address. The term as it is used herein includes content addressable memory embedded into a chip or other programmable logic device. A specific example of an embedded CAM is a CAM macro embedded into a memory chip. A CAM employed in a method or device of the invention also can include binary or ternary or other higher order CAMs as well as cascades of multiple CAMs integrated together. Binary CAMs are useful for performing exact-match searches whereas ternary and higher-order CAMs allow character matching with wildcards. CAMs of the invention also can employ, for example, an embedded random access memory (RAM) such as a static RAM (SRAM) for static processes or a dynamic RAM (DRAM) process for a dynamic storage of ternary data.

As used herein, the term “address location,” “address” or “location” is intended to mean the location of a particular item in a computer's memory device. Generally, an address location refers to a number that is assigned to each byte in memory and is used to track where data and instructions are stored. A byte is assigned a memory address whether or not it is being used to store data. Therefore, an address location indexes the position where data is stored and available to be accessed for subsequent manipulation or analysis.

As used herein, the term “contiguous” is intended to mean an uninterrupted stretch of biopolymer sequence or of data content characterizing an uninterrupted stretch. Accordingly, the term is intended to refer to a continuous region of adjoining monomer constituents corresponding to a primary sequence portion of a biopolymer. The number of adjoining monomer constituents can be, for example, at least about 3, 5, 10, 25, 50, 75, 100, 1000 or more monomers.

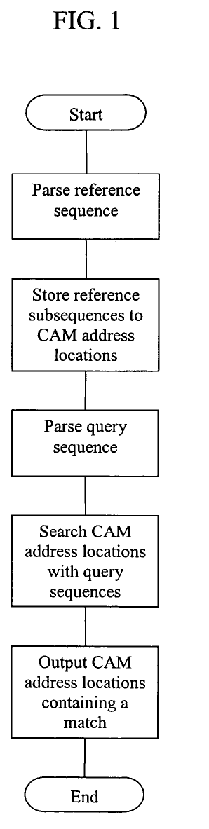

The invention provides a method of determining the similarity of two or more biopolymer sequences. The method includes the computer implemented steps: (a) parsing one or more biopolymer reference sequences to produce a plurality of reference subsequences; (b) storing the plurality of reference subsequence to a plurality of CAM address locations; (c) parsing a query sequence to produce a plurality of query subsequences; (d) searching the plurality of reference subsequences stored in the plurality of CAM address locations with the plurality of query subsequences, and (e) producing an output of CAM address locations containing a match, the match indicating sequence similarity between the reference subsequence stored in the CAM address location and the query subsequence producing the match. A flow chart diagram of the method is shown in FIG. 1.

Also provided is a method of determining the similarity of two or more biopolymer sequences. The method includes the computer implemented steps: (a) parsing one or more biopolymer reference sequences to produce a plurality of reference subsequences; (b) storing the plurality of reference subsequence to a plurality of CAM address locations in an order corresponding to an unparsed sequence of the reference sequence; (c) parsing a query sequence to produce a plurality of query subsequences; (d) searching the plurality of reference subsequences stored in the plurality of CAM address locations with the plurality of query subsequences; (e) producing an output of CAM address locations containing a match, the match indicating sequence similarity between the reference subsequence stored in the CAM address location and the query subsequence producing the match, and (f) identifying a contiguous order of CAM address locations containing a match, wherein the contiguous order indicates sequence similarity between the reference sequence and the query sequence.

The methods of the invention allow for the simultaneous processing of biopolymer sequence information for parallel comparison of the data content of a query and one or more reference sequences, allowing for the rapid and efficient identification of similar sequences by primary sequence alignment. The methods employ a CAM allowing querying of stored sequence information in parallel and output of all addresses containing sequence information matching the query sequence or sequences. Therefore, inclusion of a CAM memory device for sequence similarity or alignment determination can have a striking increase on the speed and efficiency of the similarity search or alignment routine because it can perform as a single instruction having multiple data processing operations. Further, the flexibility and modularity of CAMs also allows for the application of the methods of the invention to uniquely accommodate a wide range of job sizes without compromising the speed or efficiency of the sequence similarity searches. For example, a single similarity search can be performed or a plurality of similarity searches can be performed, including multiplex similarity searches while maintaining the same level of speed and efficiency across this range of job sizes. Typically, a plurality of reference sequences stored in a plurality of CAM addresses is searched simultaneously with a single query sequence. If desired, separate banks of CAMs can be used such that a plurality of query sequences can be used to simultaneously search a plurality of CAM addresses.

Biopolymer sequences that can be compared for sequence similarity can include any macromolecule having a repeating unit structure. Exemplary biopolymers applicable in the methods of the invention include, for example, DNA, RNA, polypeptide, lipid, carbohydrate, carbon-based polymers and other organic polymers such as polyamines and the like. The invention will be exemplified below with reference to CAM-based sequence similarity comparison of polynucleotide sequences such as DNA. However, given the teachings and guidance provided herein, those skilled in the art will understand that the CAM-based methods and the CAM-containing system of the invention are equally applicable to all biopolymers that are formed from repeating monomer units.

Biopolymer sequences for comparison using a similarity search or alignment method of the invention can be obtained from any of a variety of sources well known to those skilled in the art. Such sources include for example, user derived, public or private databases, subscription sources and on-line public or private sources. For example, databases for obtaining one or more query sequences, or for searching one or more reference sequences can include, for example, dbEST-human, UniGene-human, gb-new-EST, Genbank, Gb_pat, Gb_htgs, Refseq, Derwent Geneseq, SwissProt, EMBL-EBI and Raw Reeds Databases. Additionally, the source database of the initial reference or query or population thereof also can be searched as well. Access or subscription to these repositories can be found, for example, at the following URL addresses: dbEST-human, gb-new-EST, Genbank, Gb_pat, and Gb_htgs at URL:ftp.ncbi.nih.gov/genbank/; Unigene-human at URL:ftp.ncbi.nih.gov/repository/UniGene/; Refseq at URL:ftp.ncbi.nih.gov/refseq/; Derwent Geneseq at URL:www.derwent.com/geneseq/ and Raw Reads Databases at URL:trace.ensembl.org/. The nucleic acid reference or query sequences additionally can be generated by a user source and used directly or stored, for example, in a local database. Various other sources well known to those skilled in the art for obtaining seed or target sequence data also exist and can be similarly used in the automated methods of the invention.

The file or data format of biopolymer sequence data can include any data format that allows manipulation and storage of subsequences into words or bits of memory or allows manipulation and querying of subsequences against the sequence content stored in a CAM. Data manipulation can include, for example, parsing as well as masking, deletion, insertion and concatenation. Useful formats can include those directly or indirectly compatible with known routines or scripts as well as those that can be made compatible with known routines or scripts by, for example, inclusion of a subroutine or another script. Such data formats include, for example, FASTA, Genbank, EMBL, and plain text sequence, as well as other file formats well known to those skilled in the art.

The above data manipulations or file formats, as well as various other manipulations or formats, are well known to those skilled in the art and can be equally employed in the integrated system of the invention. Given the teachings and guidance provided herein, those skilled in the art will know how to substitute one data manipulation or file format for a comparable version. Various choices and combinations thereof will be based on, for example, user preference, computer architecture and computational resources available to the user.

A reference sequence corresponds to the sequence information content loaded into a CAM which is to be searched by a query sequence for identification of primary nucleic acid sequence similarity. A query sequence corresponds to the sequence information that will be searched against the reference sequence content resident in the CAM. Both reference and query sequences can be, for example, any form of biopolymer sequence that sequence similarity information is to be obtained. With reference to the specific example of a nucleic acid reference or query sequence, such sequences can constitute or derive from, for example, genomic sequence, such as a gene or intergenic region, or fragments thereof, as well as expressed sequences such as cDNA and ESTs, or fragments thereof. The type of reference or query sequences to employ in the methods of the invention will depend on the design of the user and the objective to be obtained. For example, a user can achieve identification of sequence similarity using any combination of a genomic region sequence, a coding sequence region or an open reading frame (ORF), a cDNA, an EST or RNA or other forms of nucleic acid. Various other forms of reference or query sequences well known to those skilled in the art, including nucleic acid fragments, exons and introns, for example, can similarly be used in the methods of the invention to obtain sequence similarity information. Given the teachings and guidance provided herein, those skilled in the art will know that biopolymer sequence similarity searches employing the methods or system of the invention can be performed with or without any prior knowledge of the reference sequence, the query sequence or both. Alternatively, search resources and time can be focused to particular categories of biopolymer sequences when sufficient information is available on the source, category or other characteristic that is known or can readily be determined.

The methods of the invention for determining the similarity of two or more biopolymer sequences can be performed by parsing one or more biopolymer reference sequence to produce a plurality of subsequences. One or more query sequences also can be parsed for identifying similar reference sequences. As described further below, the reference subsequences are loaded into a CAM whereas the query subsequences will be submitted as a user's request for information to the CAM. The designation of a biopolymer sequence or a plurality of sequences as a reference or query sequence is interchangeable because sequence information corresponding to either designation can be loaded into a CAM or submitted as a request to a CAM. Generally, the sequence or plurality of sequences within a designation having a larger amount of sequence content information will be designated as a reference sequence and loaded into one or more CAMs.

Loading of reference sequences can be initialized by parsing one or more reference sequences into a plurality of subsequences. The choice to parse a biopolymer sequence into subsequences can depend, for example, on the size of the sequence. For example, short sequences equal in length or smaller than the width (n) of a CAM address can omit parsing. Longer sequence can be parsed into lengths equal or shorter than the width of an address. Various combinations of parsing, or omitting parsing some or all portions of a reference sequence can be performed to enhance the similarity search or to rapidly generate preliminary results. Given the teachings and guidance provided herein, those skilled in the art will know or can determine the size or amount of parsing to employ for a particular application.

Similarly, various methods and algorithms well known to those skilled in the art can be used for parsing one or more biopolymer sequences into subsequences. Parsing can be carried out by any algorithm that allows a sequence to be broken into subsequences. For example the sequence ATTGC can be parsed into non-overlapping sequences of ATT and GC. Alternatively, it can be parsed into overlapping sections such as ATT, TTG, and TGC. Such methods or algorithms include, for example, chunking the sequence into a series of k-mers, wherein k is a constant integer or wherein k is any integer value in a selected range. The k-mers can be overlapping or non-overlapping. In embodiments including overlapping k-mers the overlap can be a value p that is a constant integer or a variable integer in a selected range. For example, in embodiments including chunking sequences into overlapping k-mers, the length of the sequence, k can be 25 and the value for p overlap can be any integer value in a selected range of 2 to 4.

Masking can be done via don't care values, for example, in ternary CAMs as described in further detail below. Deletions and insertions are typically not used in CAMs, in their original form. In order to use a sequence with deletion or insertion, the location of an insertion or one flanking side can be replaced with one or more don't cares. Thus, for the CAM operation the contents of the CAM will line up with the query sequence. For example, if a CAM includes the reference sequence ATGGATC and the query sequence is ATGGAT (the last nucleotide being deleted the query sequence can be represented as ATGGATX (where X is a don't care), for use in the CAM query.

A plurality of reference subsequences is stored in a plurality of CAM address locations for subsequent similarity search with one or more query sequences or subsequences. The plurality of reference subsequences can correspond to, for example, one or more reference sequences. The reference sequences can correspond to intact or native sequences, to defined regions or to fragments of known, unknown, defined or undefined sequence as selected by the user. The reference sequences also can consist of any combination of intact sequence, defined regions or fragments of known, unknown, defined or undefined sequence. Therefore, the reference sequence content stored in a CAM can contain either a single reference sequence or a plurality of different reference sequences, including a diverse array of sequences of various origins and sizes and with a varying degree of characterization.

Each reference sequence can be parsed into subsequences of width size n or smaller. Alternatively, if the reference sequences are smaller than width size n, they can be loaded directly into the CAM memory addresses. A useful width size n can be, for example, n=2^{k} wherein k is at least 2, 3, 4, 5 or 6. A plurality of reference sequences can range from two to a million or more reference sequences. For example, a plurality of reference sequences contained in a CAM for a sequence similarity search using the methods and integrated system of the invention also includes, for example, 3, 4, 5, 6, 7, 8, 9, 10 or 11 or more reference sequences. A plurality of reference sequences stored in a CAM for similarity search based on content also can include, for example, 15, 20, 25, 30, 35, 40, 45, 50, 55, 60, 65, 70, 75, 80, 85, 90 or 95 or more reference sequences. Similarly, a larger number of reference sequences ranging, for example, from 100, 500, 10³, 10⁴ or 10⁵ or more reference sequences is included in a plurality of reference sequences of the invention and also can be searched for sequence similarity using the methods and system described herein. The number of reference sequences included in a plurality also expressly includes all integer values in between the above exemplary numbers and ranges as well as expressly includes pluralities above those exemplified above. Accordingly, pluralities can consist of 10⁶, 10⁷, 10⁸ or 10⁹ or more different reference sequences.

Pluralities additionally can be generated that correspond to the sequence content of an organism's genome or an organism's proteome. The organism can be, for example, a mammal such as a human and the CAM can contain the human genome or human proteome. Some or all of the reference sequences can be parsed into reference subsequences, stored and employed in the sequence similarity searches of the invention. Therefore, the methods and integrated systems of the invention can simultaneously search the sequence information content of from one to a million or more reference sequences and produce an output corresponding to all or some addresses containing the sequence information content matching the search query.

The methods are well suited to the analysis of large genomes such as those typically found in eukaryotic unicellular and multicellular organisms. Exemplary eukaryotic genome sequences that can be used in a method of the invention includes, without limitation, that from a mammal such as a rodent, mouse, rat, rabbit, guinea pig, ungulate, horse, sheep, pig, goat, cow, cat, dog, primate, human or non-human primate; a plant such as Arabidopsis thaliana, corn (Zea mays), sorghum, oat (oryza sativa), wheat, rice, canola, or soybean; an algae such as Chlamydomonas reinhardtii; a nematode such as Caenorhabditis elegans; an insect such as Drosophila melanogaster, mosquito, fruit fly, honey bee or spider; a fish such as zebrafish (Danio rerio); a reptile; an amphibian such as a frog or Xenopus laevis; a dictyostelium discoideum; a fungi such as pneumocystis carinii, Takifugu rubripes, yeast, Saccharamoyces cerevisiae or Schizosaccharomyces pombe; or aplasmodium falciparum. A method of the invention can also be used to evaluate sequences from smaller genomes such as those from a prokaryote such as a bacterium, Escherichia coli, staphylococci or mycoplasma pneumoniae; an archae; a virus such as Hepatitis C virus or human immunodeficiency virus; or a viroid.

As described further below, CAM address locations can be contained in one or more CAMs. The reference subsequences can be stored in address locations in an ordered fashion for identification of contiguous regions within a reference sequence. Similarly, various storage patterns of reference subsequences can be employed to facilitate or augment identification of similar sequences with one or more query subsequences. For example, reference subsequences adjacently ordered in address locations that correspond to the contiguous linear sequence of the corresponding unparsed reference sequence allows quick identification of reference sequence through identification of matched adjacent addresses. Alternatively, the subsequences can be stored randomly for identification of similar reference subsequences with one or more query subsequences. Given the teachings and guidance provided herein, those skilled in the art will know whether ordered placement, including patterns and the like, or random or semi-random placement of reference subsequences in CAM memory addresses will achieve a desired goal or enhance efficiency of a similarity search using the methods of the invention. CAM addresses, when placed contiguously can provide further confidence on identification of a sequence match. For example, the sequence ATTTGCAA can reside in two consecutive addresses of: (1) ATTT and (2) GCAA. If the query sequence ATTTGCAA is input, and addresses (1) and (2) are output, then the fact that the two addresses are contiguous provides extra confidence that the ATTTGCAA is a real sequence in the reference genome. Alternatively, the relative locations of output addresses identified for a query sequence can be used to merge the sequences. For example, if the above search were carried out using two search sequences of ATTT and GCAA and contiguous addresses (1) and (2) are output, then the contiguous location of addresses (1) and (2) indicates that the two chunks (ATTT and GCAA) are parts of a contiguous region of the genome.

Reference subsequences can be stored into CAM address locations prior to or subsequent to device startup as well as prior to or subsequent to PLD configuration. CAM address locations also can be rewritten during device operation. Therefore, reference subsequences can be pre-loaded into a CAM or written during operation. Similarly, subsequence content of a CAM can be modified, substituted, reduced or expanded at any point prior to or as a step in a sequence similarity search of the invention. Such flexibility and manipulability of CAM sequence content allows a user to narrowly tailor or broadly encompass reference sequence content to provide greater specificity or efficiency of resources for any particular search criteria.

For example, sequence data can be pre-loaded into CAM address locations. Such off-line writing is advantageous because it is convenient and genome information being static is not changed during the course of typical analyses. However, static genome information need not be the same for two different CAM based searches, for example, in cases where the pre-loaded static genome information differs from one build to another. In the off-line writing embodiment, the data from each CAM can be read for evaluation of each sequence of interest. Thus, the write operation happens once and happens off-line.

A CAM includes any memory device that identifies an item in memory for access by its content rather than its address. A CAM can consist of any data storage medium which allows parallel access of information, supports associative memory functions and includes comparison logic with some or all bits of storage. CAMs employed in the methods and integrated system of the invention can consist of a variety of different configurations or formats. For example, a CAM can consist of an integrated circuit that stores data temporarily or permanently or a memory chip address bus having an embedded CAM. An embedded CAM can consist of, for example, a CAM macro. The structure of CAMs useful in the invention and methods of their manufacture are known in the art examples of which are described in Application Note AN8071, Lattice Semiconductor Corp. July (2002) and Motorola Semiconductor Technical Data, MCM69C432/D (Rev 10, 2001).

The depth of a CAM memory corresponds to the number of memory locations or addresses. Because a CAM does not need address lines to find data, the depth of a memory system using CAM can be extended as far as desired. The width of a CAM memory corresponds to the number of bits at each address location. For example, a memory location to store data can be 1 bit per address, 4 bits per address (or nibble), a byte per address (8 bits or 2 nibbles), a word per address (generally about 16 bits) or as wide as the physical size of the memory or the input allows. The width and depth of a CAM can range, for example, from small to large and multiple CAMs can be cascaded together to create wider and deeper CAMs. For example, a CAM can be configured to be a 32-word×32-bit CAM, or a 1024-word×64-bit and multiple CAMs can be cascaded together to implement wider and deeper CAMs. The depth of a CAM can be extended without the need for additional routines because the addressing is self-contained. Extending the width generally requires additional routines to match the number of word lines from chip to chip. A CAM architecture, including PLDs having integrated CAMs provides great flexibility because the user can create a wide range of CAM depths or widths. For example, cascading of 32-word×32-bit CAMs can be employed to produce memory having maximum sizes corresponding to 26,624; 40,960; 53,248; 73,728; 106,496; 155,648, and 270,336 CAM bits. Therefore, the size of a CAM can be as large or as small as is desired for a particular application or tailored to suit a particular need.

The use of PLDs for address decoding can provide several non-limiting advantages. For example a PLD having one chip requires less board area, power, and wiring than the use of chips used in other hardware configurations. Another advantage is that the design inside the chip is flexible, so a change in the logic does not require rewiring of the board with which it is used. Rather, decoding logic can be altered by simply replacing a PLD having a first logic operation with another part or PLD that carries out a different decoding logic as desired.

Inside each PLD is a set of fully connected macrocells. These macrocells typically include some amount of combinatorial logic such as AND or OR gates, and a flip-flop. Thus, a each macrocell can include a small Boolean logic equation. This equation can combine the state of some number of binary inputs into a binary output and, if necessary, store that output in the flip-flop until the next clock edge. The structure and function of the logic gates and flip-flops can be of any of a variety of desired constructions. Several varieties are available from different manufacturers and product families.

CAMs are well known in the art and can be produced using integrated circuit materials and methods well known to those skilled in the art. A review of CAM function, operation and structure as well as comparisons to other memory devices can be found described, for example, in Peng and Azgomi, “Content-Addressable Memory (CAM) and its Network Applications,” International IC—Korea, Conference Proceedings, (2000); Music Semiconductors, “What is a CAM (Content-Addressable memory)?” Application BriefAB-N6, Sep. 30, 1998, Rev.2a; Helwig and Wandel, “High Speed Content Addressable Memory,” IBM Deutschland Entwicklung GmbH (1996), and Melchior, T., “Leveraging Very Large Content Addressable Memories” UTMC Microelectronic Systems, Nov. 12, 1997. CAMs are commercially available from a variety of sources well known to those skilled in the art. Exemplary commercial suppliers of CAMs and components thereof include IBM, Corp. (White Plains, N.Y.), Altera Corp. (San Jose, Calif.) and Music Semiconductors, Inc. (San Jose, Calif.). Commercially available PLDs that can support an embedded CAM include, for example, Altera Corp. (San Jose, Calif.) and Lattice Semiconductor, Corp. (Hillsboro, Oreg.).

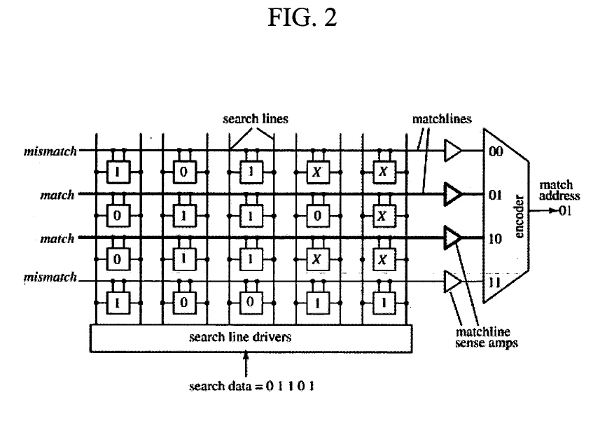

Other CAM configurations and formats useful in the methods and integrated systems of the invention include, for example, binary or ternary or other higher order CAMs as well as cascades of multiple CAMs integrated together. Binary CAMs support storage and searching of binary bits, zero or one (0,1). Ternary CAMs support storing of zero, one, or don't care bit (0,1,X). A don't care bit is a wild card representing zero or one. In the case of sequence similarity search, a don't care can represent a gap in a query or reference sequence. FIG. 2 shows a block diagram of a simplified 4×5 bit ternary CAM with a NOR-based architecture. The CAM contains the routing table from Table 1 to illustrate how a CAM can implement address lookup. The CAM core cells are arranged into four horizontal words, each five bits long. The genome alphabet of A, G, C and T can be encoded using two bits, for example, A=00, G=01, C=10, and T=11. Alternatively, one could use more bits in an attempt to include other codes, such as wild card codes. For the case of amino acids, a minimum of 5 bits can be used, since 2⁴<20<2⁵.

Core cells contain both storage and comparison circuitry. The search lines run vertically in the figure and broadcast the search data to the CAM cells. The matchlines run horizontally across the array and indicate whether the search data matches the row's word. An activated matchline indicates a match and a deactivated matchline indicates a non-match, called a mismatch in the CAM literature. The matchlines are inputs to an encoder that generates the address corresponding to the match location. This address can represent the location of the sequence of interest within the CAM.

TABLE 1

| Line No. | Address | Output port |
|---|---|---|
| 1 | 101XX | A |
| 2 | 0110X | B |
| 3 | 011XX | C |
| 4 | 10011 | D |

A CAM search operation can begin with precharging all matchlines high, putting them all temporarily in the match state. Next, the search line drivers broadcast the search data, 01101 in FIG. 2, onto the search lines. Then each CAM core cell compares its stored bit against the bit on its corresponding search lines. Cells with matching data do not affect the matchline but cells with a mismatch pull down the matchline. Cells storing an X operate as if a match has occurred. The aggregate result is that matchlines are pulled down for any word that has at least one mismatch. All other matchlines activated (precharged high). In the figure, the two middle matchlines remain activated, indicating a match, while the other matchlines discharge to ground, indicating a mismatch. Last, the encoder generates the search address location of the matching data. In this example, the encoder selects numerically the smallest numbered matchline of the two activated matchlines, generating the match address 01.

Binary CAMs are useful for performing exact-match searches and can have a structure consisting of, for example, 16K entries of 64 bits each as found in the MCM69C432/D CAM available from Motorola Corp., or 128 entries of 48 bits in width as found in the ispXPLD 5000MX CAM available from Lattice Semiconductor Corp. Ternary and higher-order CAMs that are useful in the invention can be similar to binary CAMs with the exception that the bits take more than two states, for example, in the case of a ternary CAM taking 3 states. The structure, attributes and capabilities of CAMs can be found described in, for example, Arsovski et al., IEEE J. Solid-State Circuits, 38:155-58 (2003).

Other CAM configurations and formats which can be employed in the methods of the invention include, for example, cascades of two or more CAMs. For example, a CAM used in the methods or integrated system of the invention can contain a single CAM device or from two to many individual CAM devices cascaded together. CAM cascades containing, for example, two or more, three or more, four or more, five or more, six or more, seven or more, eight or more, nine or more or ten or more can be integrated to create larger and faster memories useful in the CAM-based methods or the CAM-containing integrated system of the invention. The CAMs can be, for example, binary, ternary or higher-order CAMs as well as all combinations thereof. Similarly, CAM cascades can be performed in the width or word dimension, the depth or address dimension, both dimensions or combination of width and depth dimensions at different levels or employing different types of CAMs. An exemplary CAM cascade to achieve 32 bits using 8 bit CAMS is to place 4 of the CAMs with the same input lines going to each CAM and output from the CAMs related by an OR function.

CAMs of the invention also can be used in conjunction with RAM or can employ, for example, an embedded RAM such as a SRAM for static processes or a DRAM process for a dynamic storage of ternary data. Briefly, RAM chips are composed of arrays of cells of transistors. Each cell represents 1 bit and contains one or more transistors depending on whether it is static RAM (SRAM) or dynamic RAM (DRAM). CMOS Static RAMs generally use six transistors per cell. For example, four transistors are cross-coupled to store the state of the bit, and two are used to alter or read out the state of the bit. This configuration is called static because the state of the bit remains at one level or the other until deliberately changed, or until power is removed.

Dynamic RAMs are named for the transient nature of their storage mechanism, which commonly consists of a single transistor along with a capacitor to store the bit information. During a read, the charge on the capacitor is drained to the bit line, requiring a rewrite of the bit, called a restore operation. Additionally, because the DRAM capacitor loses charge over time, it requires its charge to be refreshed at regular intervals. To accomplish these functions, dynamic memories are accompanied by controller circuits to rewrite the bit and refresh the stored charge on a regular basis. Although more complex memory control is required, the design simplicity of a DRAM cell results in a higher density of DRAMs versus SRAMs. Neither SRAMs nor DRAMs retain information when power is removed, unless a battery backup is employed.

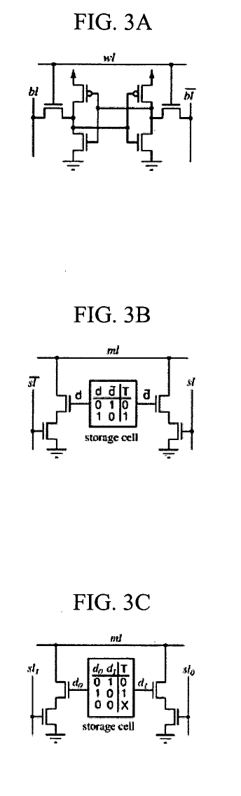

FIG. 3A displays a conventional SRAM core cell that stores data using positive feedback in back-to-back inverters. Two access transistors connect the bitlines, bl and /bl (the prefix “/” denotes the logical complement in the text and an overbar is used in FIG. 3), to the storage nodes under control of the wordline, wl. Data can be read from the cell or written into the cell through the bitlines. Thus, a CAM can be initialized by writing subsequences of a genome sequence through bitlines. Reading through bitlines can be used as a query mode in which a query sequence is compared to the contents of a CAM to identify a match. This differential cell is used as the storage for building CAM cells. FIG. 3B depicts a conventional binary CAM cell with the matchline denoted ml and the differential search lines denoted sl and /sl. A matchline can be used to identify an addressline match in a query sequence and the contents of a CAM cell.

FIG. 3A also lists the truth value, T, stored in the cell based on the values of d and /d. For a binary CAM a single bit can be stored differentially. The comparison circuitry attached to the storage cell performs a comparison between the data, such as a query sequence, on the search lines (sl and /sl) and the data in the binary cell with an XNOR operation (ml=! (d XOR sl)). A mismatch in a cell creates a path to ground from the matchline through one of the series transistor pairs. A match of d and sl disconnects the matchline from ground.

FIG. 3C shows a ternary CAM (TCAM) cell. The TCAM cell stores an extra state compared to the binary CAM, the don't care state, labeled X, which necessitates two independent bits of storage. When a don't care is stored in the cell, a match occurs for that bit regardless of the search data. A don't care is convenient for representing a gap in a sequence comparison. The figure shows that the TCAM cell stores X when d0=d1=0. The state d0=d1=1 is undefined and is not used.

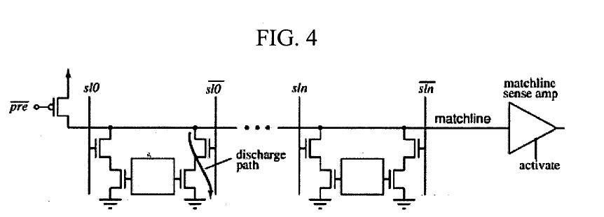

A multi-bit CAM word is a row of adjacent cells created by connecting the cells' matchlines. A useful CAM for a nucleotide search can have, for example, a minimum of k*2 bits, wherein k=11, 12, or 13. FIG. 4 depicts the relevant matchline circuitry of a single CAM row from FIG. 2. Just like a NOR gate pull down network in CMOS logic, the discharge paths on the matchline are all connected parallel giving it the name NOR-based CAM. The classic matchline sensing scheme precharges the matchline high and then asserts the search lines, s10, /s10, . . . , sln, /sln. A mismatch of any of the bits on the matchline discharges the matchline; an example discharge path is shown in FIG. 4. A match results in the matchline remaining in the precharge state which occurs if all bits in a word match.

Data can be stored in locations in a CAM in a somewhat random fashion. For example, the locations can be selected by an address bus, or the data can be written directly into the first empty location. Every location has a pair of special status bits that keep track of whether the location has valid information in it or is empty and available for overwriting. Once information is stored in a memory location, it is found by comparing every bit in memory with data placed in a special Comparand register. If there is a match for every bit in a location with every corresponding bit in the Comparand, a Match flag is asserted to let the user know that the data in the Comparand was found in memory. A priority encoder sorts out which matching location has the top priority, if there is more than one, and makes the address of the matching location available to the user.

In general, CAMs consist of memory cells that have been modified by the addition of extra transistors that compare the state of a bit stored with the state stored in a Comparand register. Logically, CAMs perform an exclusive-NOR function, so that a match is only indicated if both the stored bit and the corresponding Comparand bit are the same state. For example, a CAM can use ten-transistor cells composed of a six transistor SRAM memory cell plus four transistors to accomplish the exclusive-NOR function and match line driving, which results in what is called a Static CAM cell.

For writing and reading, each Static CAM cell functions like a normal SRAM cell, with differential bit lines to latch the value into the cell when writing, and sense amps to detect the stored value when reading. When writing, the word line is energized, turning on the pass transistors that then force the cross-coupled transistors to the levels on the bit lines. When the word line is de-energized, the cross-coupled transistors remain in the same states. For reading, the bit lines are pre-charged to the same intermediate voltage level, the word line is energized, and the bit lines are forced to the levels stored by the cross-coupled transistors. The sense amps respond to the difference in the bit lines and report the stored state to the outside world.

For comparing, the match line is pre-charged to a high level, the bit lines are driven by the levels of the bit stored in the Comparand register, but the word line is not energized, so the state of the cross-coupled transistors is not affected. The exclusive-NOR transistors compare the internally stored state of the cross-coupled transistors with the levels of the Comparand bit, and if they do not agree, the Match line is pulled down, indicating a non-matching bit. All the bits in a stored entry are connected to the same Match line, so that if any bit in a word does not match with its corresponding Comparand bit, that Match line is pulled down. Only the entries where the Match line stays HIGH are considered matches. All the Match lines are fed to a Priority encoder that determines whether any match exists, whether more than one match exists, and which matching location is considered the highest priority.

A DCAM or Dynamic CAM cell also is provided by the invention. As with DRAM, DCAMs also can be simpler than a static CAM cell, but include the refresh requirements similar to a DRAM cell. One advantage that a DCAM cell has over a SCAM cell is the ability to store “don't cares” or wildcards. Thus, a DCAM can have properties of a ternary CAM. Because a DCAM looks at the difference in charge stored on two capacitors, both capacitors can have the same charge or different charge. A difference can indicate a 1 or a 0, depending on the direction of the difference. But when they are the same charge, two additional states are available which are neither a 1 nor a 0, and one is selected to be a wildcard. For example, using an NMOS XNOR gate, both capacitors must store a 0 for a wildcard. Alternatively, a similar function can be performed by two SCAM cells to give four states, as described by Ramirez-Chavez, S., “Encoding ‘Don’t Cares' in Static and Dynamic Content-Addressable Memories,” IEEE Transactions on Circuits and Systems-II: Analog and Digital Signal Processing, Vol. 39, No. 8, August 1992. For a review of DCAM designs and their applications see, for example, Wade and Sodini, “Dynamic Cross-Coupled Bit-Line Content Addressable Memory Cell for High-Density Arrays,” IEEE Journal of Solid State Circuits, Vol. SC-22, February 1987, and U.S. Pat. No. 4,791,606.

To determine the similarity of two or more biopolymer sequences one or more query sequences are searched against the one or more reference sequences stored as reference subsequences in the CAM as described above. The one or more query sequences are parsed as described previously and searched against the references subsequences as query subsequences. Briefly, one or more queries of query subsequences can be constructed and used to search against the plurality of reference subsequences stored in a CAM. A query is a user's or agent's request for information, generally as a request to a data storage device such as a CAM, database or to a search engine. In the methods of the invention, the request is for a search of one or more reference subsequences and to identify sequences that exhibit significant or substantial alignment to the input query subsequence data. A specific example of a query that can be used in the methods of the invention can be in formats that include, for example, FASTA, Genbank, EMBL, and plain text sequence, as well as other formats well known to those skilled in the art. Typically, queries in multiple formats are converted to a single format such as machine format for making a CAM query. For example, a format useful for querying binary CAMs is a machine format using a sequence of 1 and 0 values. The search queries can consist of a single query subsequence or a plurality of query subsequences. A query subsequence can be simultaneously searched against the reference subsequence content in some or all CAM addresses and matches returned as an output.

As described previously, the output of a CAM-based similarity search of the invention will be the address locations of reference subsequences containing a match with a query subsequence. A match indicates sequence similarity between the reference subsequence located at the matched address and the query subsequence aligning with the reference subsequence. Additionally, the output will generate all matches identified by one or a plurality of query subsequences. Alternatively, various routines well known in the art can be employed to narrow the output to less than all matches. Such routines can, for example, require the satisfaction of one or more other criteria, which can be set by the user to accomplish a more focused output.

A match can correspond to exact sequence identity or it can correspond to significant or substantial sequence similarity. For example, requiring a bit-by-bit match between query and reference subsequences will generate an output of exact sequence identity. Employing a binary CAM in the methods and system of the invention is useful to accomplish such identical sequence matches. Alternatively, wildcards can be set in the sequence content comparison as described previously. The wildcard will signal a “don't care” for that bit of information and therefore enable the identification of similar, but non-identical, sequence matches. The number of wildcards employed in the search query will determine the degree of sequence similarity between matched query and reference subsequences. Employing a ternary or higher-order CAM in the methods and systems of the invention is useful to accomplish the identification of similar, but non-identical sequences. Further, the wildcard can be defined to encompass any monomer of a biopolymer sequence or a subset of monomers, where only the subset signals a “don't care” while the excluded monomers from the subset signal a not match for that bit of sequence information.

In embodiments where use of don't cares is not desired, a way to implement wildcards is to provide all the possibilities in a query. For instance in ATNGG, N is a wildcard and stands for A, G, T, or C. Exhaustively replacing a wildcard, would yield four sequences: ATAGG, ATGGG, ATTGG and ATCGG. Instead of making one query, four different queries can be made against the data in CAM, each query including one of the above variants of the ATNGG sequence. Given the teachings and guidance provided herein, those skilled in the art will know how and where to employ wildcards to generate sequence similarity outputs tailored to a desired purpose.

Matches corresponding to two or more contiguous address locations indicate sequence similarity between sequences larger in size than the subsequences alone. Ordered matches further indicate identification of sequence similarity between a reference and query sequence having a probability greater than that expected for the random occurrence of short biopolymer sequences corresponding to the size of the subsequences because the contiguous match indicates similarity between sequence portions corresponding to, for example, two, three or four or more times the length of a subsequence. Therefore, the increased probability of identifying matched sequences within an ordered CAM content further indicates sequence similarity between the larger reference and query sequences. Once the matches are identified, the address locations identified by the output can be accessed and the sequence content stored at these addresses can be obtained to show the portion of the one or more reference sequences, including the entire one or more reference sequences, having sequence similarity to the one or more query sequences employed in the alignment.

A CAM output corresponding to all the subsequences of a query sequence can be integrated in order to make a final match/no-match call for a query sequence searched against a genome or other reference sequence. Alternatively, a continuous score or probability score can be output in place of a match/no-match call. In the case of a continuous score, instead of giving 1 or 0 values, for pass or fail, respectively, a real value is assigned. A real value that is assigned can be, for example, a value between 0 and 1. In embodiments wherein the continuous score correlates with the level of confidence in a sequence alignment, it provides a probability score.

The methods of the invention additionally correspond to an algorithm. The algorithm can be formulated as written instructions including, for example, computer readable code such as C or C++, assembly language, scripts such as Per1, or applications for automated implementation by a computer system containing CAM as a content searchable memory component. Therefore, the invention also provides an integrated system for comparing the similarity of two or more biopolymer sequences. The integrated system includes the computer implemented steps: (a) a programmable logic device containing a CAM, and (b) an alignment algorithm. The alignment algorithm includes the computer implemented steps: (1) parsing one or more biopolymer reference sequences to produce a plurality of reference subsequences; (2) storing the plurality of reference subsequence to a plurality of CAM address locations; (3) parsing a query sequence to produce a plurality of query subsequences; (4) searching the plurality of reference subsequences stored in the plurality of CAM address locations with the plurality of query subsequences, and (5) producing an output of CAM address locations containing a match, the match indicating sequence similarity between the reference subsequence stored in the CAM address location and the query subsequence producing the match.

The CAM-based methods and CAM-containing integrated system for determining the similarity of two or more biopolymer sequences also can be used in conjunction with other alignment algorithms, programs or systems known in the art. The use can include, for example, complementing, augmenting or corroborating the results obtained using the methods and system of the invention. For example, methods for aligning two or more nucleic acid or amino acid sequences are well known in the art and include, for example, local sequence alignment, pairwise alignment and multiple alignment. Similarly, alignment algorithms and written instructions for their automated implementation are well known to those skilled in the art. Such algorithms and instructions include, for example, dynamic programming, heuristic algorithms, linear space, hidden Markov models (HMM), Barton-Sternberg algorithm, profile HMMs, Feng-Doolittle progressive alignment, multidimensional dynamic programming, Smith-Waterman algorithm, Needleman-Wunsch algorithm, BLAST, FASTA, d2_cluster, Phrap, and ClustalW. Any of these methods, as well as others well known to those skilled in the art can be used in conjunction or to supplement the methods and integrated system of the invention.

It is understood that modifications which do not substantially affect the activity of the various embodiments of this invention are also included within the definition of the invention provided herein. Accordingly, the following examples are intended to illustrate but not limit the present invention.

Throughout this application various publications have been referenced within parentheses. The disclosures of these publications in their entireties are hereby incorporated by reference in this application in order to more fully describe the state of the art to which this invention pertains.

The term “comprising” is intended herein to be open-ended, including not only the recited elements, but further encompassing any additional elements. Although the invention has been described with reference to the disclosed embodiments, those skilled in the art will readily appreciate that the specific examples and studies detailed above are only illustrative of the invention. It should be understood that various modifications can be made without departing from the spirit of the invention. Accordingly, the invention is limited only by the following claims.

What is claimed is:

1. A method of determining the similarity of two or more biopolymer sequences, comprising the computer implemented steps:
(a) parsing one or more biopolymer reference sequences to produce a plurality of reference subsequences;
(b) storing said plurality of reference subsequences to a plurality of content addressable memory (CAM) address locations;
(c) parsing a query sequence to produce a plurality of query subsequences;
(d) searching said plurality of reference subsequences stored in said plurality of CAM address locations with said plurality of query subsequences, and
(e) producing an output of CAM address locations containing at least one match, said at least one match indicating sequence similarity between said reference subsequence stored in said CAM address location and said query subsequence producing said at least one match.

2. The method of claim 1, wherein said reference subsequences comprise a size n, where n corresponds to a width of a memory chip address bus having said CAM embedded therein.

3. The method of claim 1, wherein said query subsequences comprise a size n, where n corresponds to a width of a memory chip address bus having embedded said CAM.

4. The method of claim 1, wherein said plurality of reference subsequences are stored in said plurality of CAM address locations randomly.

5. The method of 1, wherein said plurality of reference subsequences are stored in said plurality of CAM address locations in an order corresponding to an unparsed sequence of said reference sequence.

6. The method of claim 1, further comprising storing one reference subsequence of said plurality of reference subsequences in one CAM address location of said plurality of CAM address locations.

7. The method of claim 1, wherein said CAM comprises an embedded DRAM.

8. The method of claim 1, wherein said CAM comprises an embedded SRAM.

9. The method of claim 1, wherein said one or more biopolymer reference sequences comprises a plurality of reference sequences.

10. The method of claim 8, wherein said plurality of reference sequences is selected from the number consisting of 3, 4, 5, 6, 7, 8, 9, 10 or 11 or more reference sequences.

11. The method of claim 8, wherein said plurality of reference sequences is selected from the number consisting of 15, 20, 25, 30, 35, 40, 45, 50, 55, 60, 65, 70, 75, 80, 85, 90 or 95 or more reference sequences.

12. The method of claim 8, wherein said plurality of reference sequences is selected from the number consisting of 100, 500, 10³, 10⁴ or 10⁵ or more reference sequences.

13. The method of claim 8, wherein said plurality of reference sequences corresponds to a genome.

14. The method of claim 8, wherein said plurality of reference sequences corresponds to a proteome.

15. The method of claim 1, wherein said at least one match comprises a wildcard.

16. The method of claim 1, wherein step (b) comprises storing said plurality of reference subsequence to a plurality of CAM address locations in an order corresponding to an unparsed sequence of said reference sequence.

17. The method of claim 15, further comprising:
(a) identifying a contiguous order of CAM address locations containing at least one match, wherein said contiguous order indicates sequence similarity between said reference sequence and said query sequence.

18. An integrated system for comparing the similarity of two or more biopolymer sequences, comprising the computer implemented steps:
(a) a programmable logic device containing a CAM, and
(b) an alignment algorithm comprising the computer implemented steps:
(1) parsing one or more biopolymer reference sequences to produce a plurality of reference subsequences;
(2) storing said plurality of reference subsequences to a plurality of CAM address locations;
(3) parsing a query sequence to produce a plurality of query subsequences;
(4) searching said plurality of reference subsequences stored in said plurality of CAM address locations with said plurality of query subsequences, and
(5) producing an output of CAM address locations containing at least one match, said at least one match indicating sequence similarity between said reference subsequence stored in said CAM address location and said query subsequence producing said at least one match.

19. The integrated system of claim 18, wherein said programmable logic device comprises macrocells capable of performing combinatorial logic functions.

20. The integrated system of claim 18, wherein said CAM comprises two or more CAMs cascaded together.

21. The integrated system of claim 20 wherein said two or more CAMs further comprise three or more CAMs.

22. The integrated system of claim 20, wherein said two or more CAMs further comprise eight or more CAMs.

23. The integrated system of claim 20, wherein said two or more CAMs further comprise cascading in the word dimension.

24. The integrated system of claim 20, wherein said two or more CAMs further comprise cascading in the address dimension.

25. The integrated system of claim 21, wherein said three or more CAMs further comprise cascading in both the word dimension and the address dimension.

26. The integrated system of claim 18, wherein said reference subsequences comprise a size n, where n corresponds to a width of a memory chip address bus having said CAM embedded therein.

27. The integrated system of claim 18, wherein said query subsequences comprise a size n, where n corresponds to a width of a memory chip address bus having embedded said CAM.

28. The integrated system of claim 18, wherein said plurality of reference subsequences are stored in said plurality CAM address locations randomly.

29. The integrated system of 18, wherein said plurality of reference subsequences are stored in said plurality of CAM address locations in an order corresponding to an unparsed sequence of said reference sequence.

30. The integrated system of claim 18, further comprising storing one reference subsequence of said plurality of reference subsequences in one CAM address location of said plurality of CAM address locations.

31. The integrated system of claim 18, wherein said CAM comprises a binary CAM.

32. The integrated system of claim 18, wherein said CAM comprises a ternary CAM.

33. The integrated system of claim 18, wherein said CAM comprises an embedded DRAM.

34. The integrated system of claim 18, wherein said CAM comprises an embedded SRAM.

35. The integrated system of claim 18, wherein said one or more biopolymer reference sequences comprises a plurality of reference sequences.

36. The integrated system of claim 35, wherein said plurality of reference sequences is selected from the number consisting of 3, 4, 5, 6, 7, 8, 9, 10 or 11 or more reference sequences.

37. The method of claim 36, wherein said plurality of reference sequences is selected from the number consisting of 15, 20, 25, 30, 35, 40, 45, 50, 55, 60, 65, 70, 75, 80, 85, 90 or 95 or more reference sequences.

38. The integrated system of claim 35, wherein said plurality of reference sequences is selected from the number consisting of 100, 500, 10³, 10⁴ or 10⁵ or more reference sequences.

39. The integrated system of claim 35, wherein said plurality of reference sequences corresponds to a genome.

40. The integrated system of claim 35, wherein said plurality of reference sequences corresponds to a proteome.

41. The integrated system of claim 18, wherein said at least one match comprises a wildcard.
